(19) United States
(12) Patent Application Publication
(10) Pub. No.: US 2010/0215313 A1
(43) Pub. Date: Aug. 26, 2010

(54) OPTICAL INTERCONNECTION ASSEMBLED CIRCUIT

(75) Inventors: YASUNOBU MATSUOKA, HACHIOJI (JP); KOICHIRO ADACHI, MUSASHINO (JP); TOSHIKI SUGAWARA, KOKUBUNJI (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/699,345

(22) Filed: Feb. 3, 2010

(30) Foreign Application Priority Data
Feb. 20, 2009 (JP) 2009-038098

(51) Int. Cl. G02B 6/12; G02B 6/36

(52) U.S. Cl. 385/14; 385/88

(57) ABSTRACT

An optical interconnection assembled circuit capable of reducing the number of parts and components, as well as the number of manufacturing processes and capable of mounting those parts and components at a high density in an optical module, thereby realizing a low price. The optical interconnection assembled circuit includes a substrate including plural optical waveguides having partial tapered surfaces respectively, as well as an optical element array facing each of the tapered surfaces. In the optical interconnection assembled circuit, the tapered surfaces and the optical element array are fastened so that they face each other and the optical elements of the optical element array are staggered in disposition.

### CLAIM OF PRIORITY

The present application claims priority from Japanese patent application JP 2009-038098 filed on Feb. 20, 2009, the content of which is hereby incorporated by reference into this application.

### FIELD OF THE INVENTION

The present invention relates to an optical interconnection assembled circuit.

### BACKGROUND OF THE INVENTION

Recently, in the field of information and telecommunications, optical communication traffics have been rapidly expanding to send/receive large capacity data. And so far, fiber-optic networks have been developed in order to meet the requirements of such optical communications in comparatively long distances of more than a few kilometers for backbone, metro, and access systems. In the near future, optical fibers will be used more and more for signal wirings to process large capacity data quickly even in extremely short distances of rack-to-rack (from a few meters to a few hundred meters) or of intra-rack (from a few centimeters to a few tens of centimeters).

If an optical fiber wiring is employed for a transmission apparatus, an apparatus router/switching device inputs high-frequency signals received through the optical fiber wiring from external such as the Ethernet to its line card in the apparatus. In this case, the apparatus includes plural line cards provided for one backplane. Input signals of each line card are collected in a switching card through the backplane, then processed by an LSI in the switching card and output to each line card again through the backplane. Here, in case of such a recent present transmission apparatus, signals of more than a few hundred Gbps are collected from each line card into the switching card. To transmit those signals through a conventional electrical wiring, it will be required to divide each signal transmission rate into approximately 1 to 3 Gbps per wiring so as to cope with the propagation loss. Thus a few hundred or more wirings come to be required for the transmission.

Furthermore, a pre-emphasis equalizer will also be required for those high frequency wirings in addition to some countermeasures to solve the problems of reflection or crosstalk that might otherwise occur between wirings. In the near future, communication systems will further be expanded in capacity. And in case of such systems required to process information of Tbps or more respectively, it will be more difficult for conventional electrical wirings to cope with increasing the number of wirings, as well as to cope with the crosstalk problems as described above. On the other hand, if an optical signal line is employed for the communications between each line card and a switching card in a transmission apparatus, high-frequency signals of 10 Gbps or over can be reduced at a lower propagation loss, so that the countermeasures as described above can be omitted even when less wirings are used for transmitting high-frequency signals. This technique will thus be favorable for such future communications.

In order to realize a large capacity optical interconnection assembled circuit capable of coping with large capacity data as described above, therefore, high density disposition of optical elements and optical wirings is indispensable. A simple mounting technique for enabling easier manufacturing/forming methods of such optical elements and wirings will also become necessary. JP-A-2003-114365 discloses an exemplary embodiment of how to mount a multilayer optical waveguide array and an photonic device array that are connected to each other through high-densely disposed optical fibers in an optical interconnection assembled circuit. FIG. 12 shows a drawing for describing this optical connection. In this example, optical wiring layers 101A and 101B that are optical waveguides are formed in layers in the thickness direction of the substrate and those optical wiring layers are connected optically to the planar light emitting (receiving) type photonic device arrays 100 disposed in a row on the surface of the substrate. The photonic device arrays 100 and the optical wiring layers 101A and 101B are connected optically through array type optical coupling optical waveguide units 104A and 104B extended vertically with respect to the substrate.

Furthermore, JP-A-2007-156114 discloses a method for enabling the connection between an optical wiring and a photonic device that have lenses at their surfaces facing each other.

### SUMMARY OF THE INVENTION

In case of the optical connection between the multilayer optical waveguide array and the optical element array as disclosed in the patent documents 1 and 2, those components are disposed like rows. Thus it is difficult to say that the two-dimensional layout is an efficient way for them.

And if the pitch between optical elements is narrowed so as to realize high-density disposition, such pitch narrowing often causes optical cross-talks. The narrowing comes to be limited as a matter of course.

Furthermore, as disclosed in the patent documents 1 and 2, if lenses and array type optical coupling optical waveguide units 104A and 104B disposed in the vertical direction are used as additional components, it is required to mount those components one by one while the optical waveguide and the photonic device are positioned, thereby the number of parts/components and the number of manufacturing processes increase.

Under such circumstances, it is an object of the present invention to provide an optical interconnection assembled circuit capable of reducing the number of parts/components, as well as the number of manufacturing processes to realize a low price and capable of mounting the parts and components at a high density.

Hereunder, there will be described briefly some typical examples of the present invention.

In order to solve the conventional problems as described above, the optical interconnection assembled circuit of the present invention is configured as follows. Above the top surface of one end of the mirror part of each optical waveguide array is disposed a laser diode array, which emits a light vertically with respect to a semiconductor substrate and has a lens on the semiconductor substrate. The mirror part including a clad and a core that are laminated on the substrate has a tapered surface at both ends thereof or around them. And above the top surface of the other end of the mirror part of the optical waveguide array is disposed a photo diode array, which receives the light vertically with respect to the semiconductor substrate and having a lens on the substrate. The light is exchanged between the optical element array and the optical waveguide array core through the lenses provided on the semiconductor substrate of the optical element and the mirror part of the optical waveguide layer.

Furthermore, the optical interconnection assembled circuit of the present invention is configured as follows. The beam emitting parts of each laser diode array and the lenses provided on the semiconductor substrate at the positions corresponding to those beam emitting parts are staggered in disposition between adjacent channels. The cores and the mirror parts of each optical waveguide array are also staggered in disposition between adjacent channels. And light signals are exchanged between each light emitting array and the core of each optical waveguide array through each of the lenses provided on the semiconductor substrate of the laser diode and each of the mirror parts of the optical waveguide layer.

Furthermore, the optical interconnection assembled circuit of the present invention is configured as follows. On a semiconductor substrate are provided plural first laser diode array channels, as well as plural second laser diode array channels disposed adjacently and linearly to the first light emitting array channels. Each of those first and second laser diode array channels has lenses disposed linearly at the beam emitting parts of each laser diode array, for example, each laser diode array and at the positions corresponding to those beam emitting parts on the semiconductor substrate. Those first and second optical waveguide array channels are disposed linearly and laminated in the thickness direction of the substrate. The cores and mirror parts of those channels are disposed on the semiconductor substrate linearly. And light signals are exchanged between each first laser diode array channel and the core of each optical waveguide array channel, as well as between each second laser diode array channel and the core of each optical waveguide array through the lens provided on the semiconductor substrate of each laser diode and the mirror part of each optical waveguide array.

Hereunder, there will be described briefly the effects of the present invention to be obtained by the typical embodiments disclosed in this specification.

According to the present invention, above the top surface of one end mirror part of each optical waveguide array is mounted one of plural optical element arrays having lenses on the same semiconductor substrate respectively. And a light is exchanged between the optical element array and the core of the optical waveguide array through the lenses provided on the semiconductor substrate of each optical element and the mirror part of the optical waveguide layer, thereby the optical connection loss that might otherwise caused by the spreading of the light beam output from the light omitting element or the optical waveguide can be suppressed without requiring any optical part between the optical waveguide and a photonic device. Furthermore, because the lens can be formed together with the optical element array on the same semiconductor substrate in the optical element array manufacturing process, it is possible to decrease the number of parts and components, as well as the number of manufacturing processes while preventing the manufacturing yield from worsening that has been a conventional problem.

Furthermore, the beam emitting parts of the laser diode arrays and the lenses provided on the semiconductor substrate at the positions corresponding to those beam emitting parts, as welt as the cores and the mirror parts of the optical waveguide arrays are staggered alternately in disposition between adjacent channels, thereby the pitch of the channels can be more narrowed and signal lines can be disposed more densely than the case in which those parts, components, and signal lines are disposed linearly.

Furthermore, the optical interconnection assembled circuit of the present invention is configured as follows. On a semiconductor substrate are provided plural first laser diode array channels, as well as plural second laser diode array channels disposed adjacently and linearly to the first light emitting array channels. Each of those first and second laser diode array channels has lenses disposed linearly at the beam emitting parts of each laser diode array and at the positions corresponding to those beam emitting parts on the semiconductor substrate. Those first and second optical waveguide array channels are disposed linearly and laminated in the thickness direction of the substrate. The cores and mirror parts of those channels are disposed on the semiconductor substrate linearly, thereby the optical wirings come to be disposed at a higher density.

Even in the above case, because optical connections are made through the lenses provided on the semiconductor substrate of the optical elements and the mirror parts of the optical waveguide layer respectively, no optical part is required between each optical waveguide and the optical photonic device. Thus the number of parts and components, as well as the number of manufacturing processes can be reduced and high density disposition of optical wirings can be made in various highly flexible layouts.

This is why the present invention can provide an optical interconnection assembled circuit having an optical element structure and an optical connection part capable of realizing the most efficient high density disposition of parts, components, wirings, etc.

### BRIEF DESCRIPTION OF THE DRAWINGS

FIG. 1A is a perspective view of an optical interconnection assembled circuit with respect to a schematic configuration employed in the first embodiment of the present invention;

FIG. 1B is a top view of the optical interconnection assembled circuit with respect to the schematic configuration employed in the first embodiment of the present invention;

FIG. 1C is a cross sectional view taken on line A-A of FIG. 1B;

FIG. 1D is a cross sectional view taken on line B-B of FIG. 1B;

FIG. 2A is a cross sectional view of a laser diode array to be built in the optical interconnection assembled circuit in the first embodiment of the present invention with respect to a manufacturing process (in which a epitaxial layer is formed on the semiconductor substrate);

FIG. 2B is a cross sectional view of the laser diode array with respect to another manufacturing process (in which the epitaxial layer is subjected to a treatment process to form a beam emitting part) continued from that in FIG. 2A;

FIG. 2C is a cross sectional view of the laser diode array with respect to still another manufacturing process (in which a passivation is patterned on the surface of the semiconductor substrate, which is on the opposite side of the epitaxial layer) continued from that in FIG. 2B;

FIG. 2D is still another cross sectional view of the optical element array with respect to still another manufacturing process (in which lenses are formed on the semiconductor substrate) continued from that in FIG. 2C;

FIG. 3A is a cross sectional view of a light waveguide substrate to be built in the optical interconnection assembled circuit in the first embodiment of the present invention with respect to a manufacturing process (in which a clad layer is formed on the substrate);

FIG. 3B is another cross sectional view of the light waveguide substrate with respect to a manufacturing process (in which a core pattern is formed on the clad layer) continued from that in FIG. 3A;

FIG. 3C is still another cross sectional view of the light waveguide substrate with respect to still another manufacturing process (in which tapered mirror parts (tapered surfaces) are formed at both ends of a core pattern) continued from that in FIG. 3B;

FIG. 3D is still another cross sectional view of the light waveguide substrate with respect to still another manufacturing process (in which the core pattern is covered by a clad layer) continued from that in FIG. 3C;

FIG. 4A is another cross sectional view of the optical interconnection assembled circuit in the first embodiment of the present invention with respect to a manufacturing process (in which a laser diode array is mounted on an optical waveguide substrate);

FIG. 4B is another cross sectional view of the optical interconnection assembled circuit in the first embodiment of the present invention with respect to another manufacturing process (in which a photo diode array is mounted on an optical waveguide substrate);

FIG. 5 is a flat (top) view of an optical interconnection assembled circuit in a variation of the first embodiment of the present invention;

FIG. 6 is a flat (top) view of an optical interconnection assembled circuit in the third embodiment of the present invention;

FIG. 7A is a flat (top) view of the optical interconnection assembled circuit in the variation of the first embodiment of the present invention;

FIG. 7B is a cross sectional view taken on line C-C of FIG. 7A;

FIG. 7C is a cross sectional view taken on line D-D of FIG. 7A;

FIG. 8A is a flat (top) view of an optical interconnection assembled circuit in the fourth embodiment of the present invention;

FIG. 8B is a cross sectional view taken on line E-E of FIG. 8A;

FIG. 8C is a cross sectional view taken on line F-F of FIG. 8A;

FIG. 9 is a cross sectional view of an optical interconnection assembled circuit in the fifth embodiment of the present invention;

FIG. 10 is a cross sectional view of an optical interconnection assembled circuit in the sixth embodiment of the present invention;

FIG. 11 is a schematic view of an optical interconnection assembled circuit in the seventh embodiment of the present invention; and

FIG. 12 is a drawing for describing a multilayer optical waveguide array and a photonic device array that are connected optically to each other at a high density in a conventional embodiment;

### DETAILED DESCRIPTION OF THE PREFERRED EMBODIMENTS

Hereunder, there will be described the embodiments of the present invention in detail with reference to the accompanying drawings.

### First Embodiment

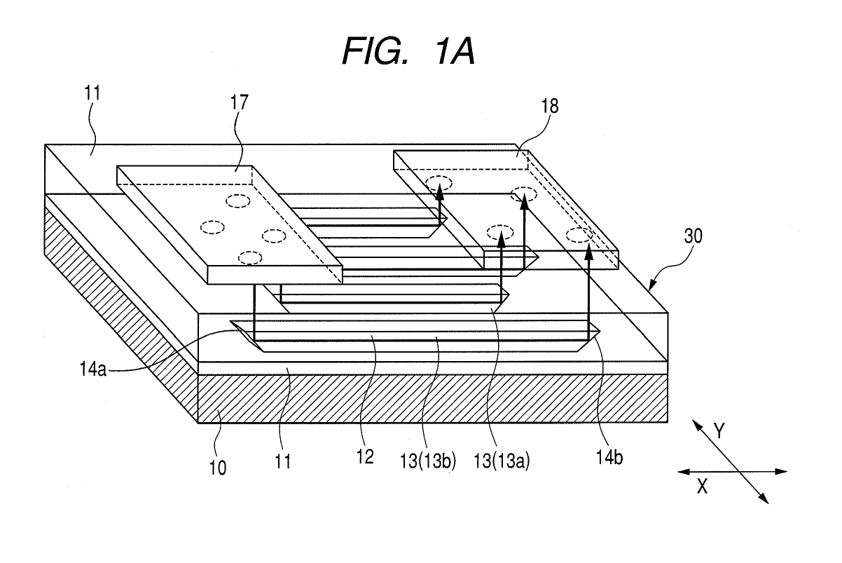

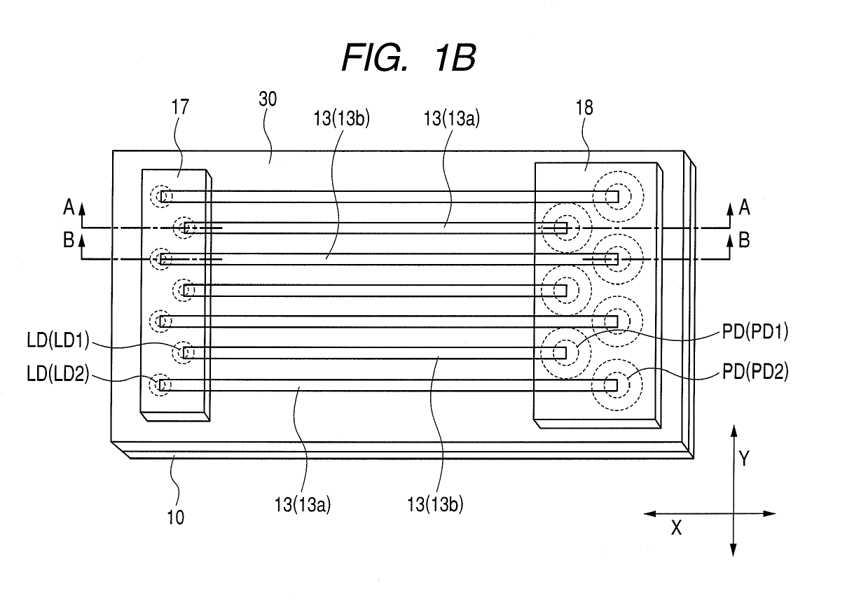

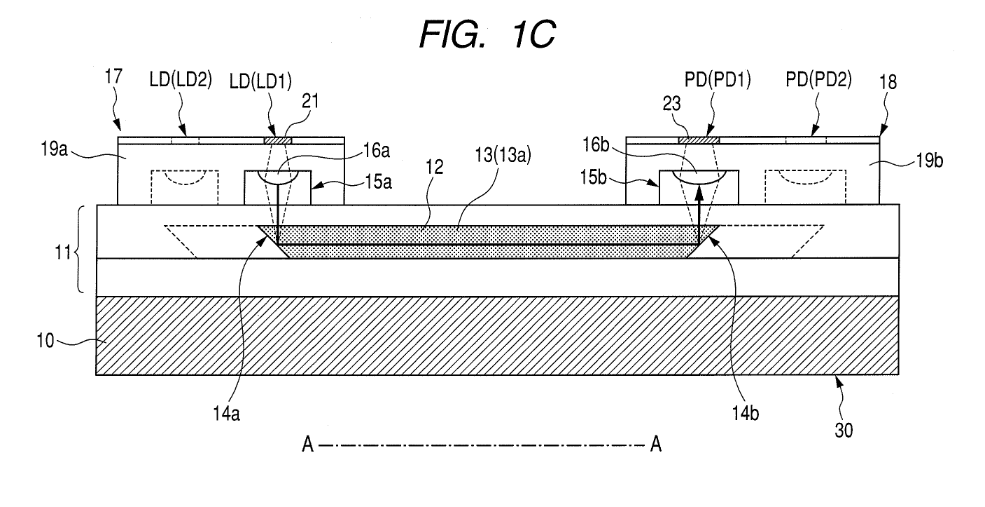

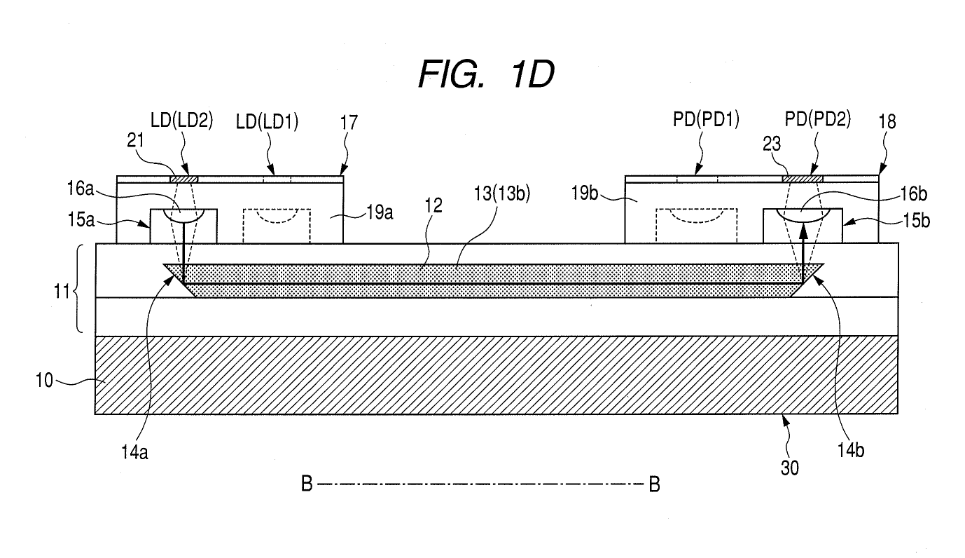

FIGS. 1A through 1D are drawings related to an optical interconnection assembled circuit in this first embodiment of the present invention.

FIG. 1A is a perspective view of the optical interconnection assembled circuit.

FIG. 1B is a flat (top) view of the optical interconnection assembled circuit.

FIG. 1C is a cross sectional view taken on line A-A of FIG. 1B.

FIG. 1D is a cross sectional view taken on line B-B of FIG. 1B.

As shown in FIGS. 1A through 1D, the optical interconnection assembled circuit in this first embodiment includes, for example, a laser diode array 17 and a photo diode array 18 assumed as optical element arrays, as well as an optical waveguide substrate 30 used for the optical connection between those optical element arrays (the laser diode array 17 and the photo diode array 18).

The optical waveguide substrate 30 includes a multi-channel optical waveguide array consisting of plural optical waveguides 13 on the same substrate. On the same plane, those waveguides 13 are extended in the first direction (e.g., X direction) and arranged side by side in the second direction that is orthogonal to the first direction. The substrate 10 is made of, for example, glass epoxy, ceramic, a semiconductor material, or the like. Each of the optical waveguides 13 is enclosed by a clad layer 11 formed on the substrate 10. The main part of each optical waveguide 13 is a core 12 made of a material of which refractive index is higher than that of the clad layer 11. Each of the optical waveguides 13 has mirror parts (reflection parts) 14a and 14b formed at its both ends (to be described as one end and the other end later). The surfaces of those ends 14a and 14b are tapered respectively to change the direction of the transmitted light path approximately vertically with respect to the extended direction of each of the optical waveguides 13. The mirror part 14a provided at one end is inclined by about 45° counterclockwise with respect to the direction of the thickness of the clad layer 11 or the substrate 10. The mirror part 14b provided at the other end is also inclined by about 45° clockwise with respect to the direction of the thickness of the clad layer 11 or the substrate 10.

In this first embodiment, the optical waveguides 13 are divided into two types; optical waveguides 13a (FIG. 1C) and optical waveguides 13b (FIG. 1D) of which optical paths are longer than those of the optical waveguides 13a respectively. These optical waveguides 13a and 13b are disposed alternately in the second direction so that the mirror part 14a provided at one end of each optical waveguide 13b is disposed inside the mirror part 14a provided at one end of each optical waveguide 13b (positioned closer to the mirror part 14b provided at the other end of the optical waveguide 13a) while the mirror part 14b provided at the other end of each optical waveguide 13a is disposed inside the mirror part 14b provided at the other end of each optical waveguide 13b (positioned closer to the mirror part 14a provided at one end of the optical waveguide 13a). This means that the optical waveguide array in this first embodiment is formed so that the mirror parts 14a provided at one ends and the mirror parts 14b provided at the other ends of the plural optical waveguides 13 respectively are staggered in disposition.

The laser diode array 17 includes plural laser diodes LD corresponding to the number of the provided optical waveguides 13. All those plural laser diodes LD are formed on, for example, one common semiconductor substrate 19a (FIGS. 1C and 1D). Those laser diodes LD of the laser diode array 17 are also staggered in disposition corresponding to the staggered disposition of the mirror parts 14a provided at one ends of the plural optical waveguides 13 (FIG. 1B). The photo diode array 18 includes plural photo diodes PD corresponding to the number of the provided optical waveguides 13 and all those plural photo diodes PD are formed on, for example, one common semiconductor substrate 19b (FIGS. 1C and 1D). Those photo diodes PD of the photo diode array 18 are also staggered in disposition corresponding to the staggered disposition of the mirror parts 14b provided at the other sides of the plural optical waveguides 13 (FIG. 1B).

Furthermore, the laser diode array 17 is disposed on the clad layer 11 so that the plural laser diodes LD come over the mirror parts 14a provided at one ends of the plural optical waveguides 13 in the top view, that is, those laser diodes LD come to face the mirror parts 14a respectively (FIGS. 1C and 1D). The photo diode array 18 is also disposed on the clad layer 11 so that the plural photo diodes PD come over the mirror parts 14b provided at the other sides of the plural optical waveguides 13 in the top view, that is, those photo diodes PD come to face the mirror parts 14b respectively (FIGS. 1C and 1D).

As described above, the laser diode array 17 includes plural laser diodes LD staggered in disposition corresponding to the staggered disposition of the mirror parts 14a provided at one ends of the plural optical waveguides 13. In other words, the laser diode array 17 includes the laser diode LD1 in the first row (closer to the photo diode array 18) and the laser diode LD2 in the second row (farther from the photo diode array 18). The laser diode LD1 in the first row is disposed corresponding to the mirror part 14a provided at one end of one 13a of the plural optical waveguides 13 (inside the mirror part 14a provided at one end of one optical waveguide 13b) while the laser diode LD2 in the second row is disposed corresponding to the mirror part 14a provided at one end of one 13b of the plural optical waveguides 13 (outside the mirror part 14a provided at one end of one optical waveguide 13a) so as to be shifted by half a pitch from the laser diode LD1 in the first row.

Just like the laser diode array 17, the photo diode array 18 also includes plural photo diodes PD staggered in disposition corresponding to the staggered disposition of the mirror parts 14b provided at the other ends of the plural optical waveguides 13. In other words, in the photo diode array 18, the photo diode PD1 and the photo diode PD2 are disposed sequentially in this order from the laser diode array 17. And the photo diode PD1 is disposed corresponding to the mirror part 14b provided at the other end of one 13a of the plural optical waveguides 13 (inside the mirror part 14b provided at the other end of one optical waveguide 13b) and the photo diode PD2 is disposed corresponding to the mirror part 14b provided at the other end of one 13b of the plural optical waveguides 13 (outside the mirror part 14b provided at the other end of one optical waveguide 13a) so as to be shifted by half a pitch from the photo diode PD1 in the first row.

This means that the optical interconnection assembled circuit in this first embodiment is configured so that the first row laser diode LD1 of the laser diode array 17 (inside that in the second row) and the first row photo diode PD1 of the photo diode array 18 (inside that of the second row) are connected optically to each other (inside-inside optical connection) in the optical waveguide 13a of which optical path is longer than that of the optical waveguide 13b and the second row laser diode LD2 of the laser diode array 17 (outside that in the first row) and the second row photo diode PD2 of the photo diode array 18 (outside that in the first row) are connected optically to each other in the optical waveguide 13b of which optical path is longer than that of the optical waveguide 13a (outside-outside optical connection).

Each of the plural laser diodes LD of the laser diode array 17 includes a recessed part 15a recessed from the second surface of the semiconductor substrate 19a toward the first surface formed at the opposite side of the second surface, a lens 16a provided at the bottom surface of this recessed part 15a, and a beam emitting parts 21 provided on the semiconductor substrate 19a at the first surface side so as to correspond to this lens 16a. The beam emitting part 21 emits a light vertically to the semiconductor substrate 19a (thickness direction).

Each of the plural photo diodes PD of the photo diode array 18 includes a recessed part 15b recessed from the second surface of the semiconductor substrate 19b toward the first surface provided at the opposite side of the second surface, a lens 16b provided at the bottom surface of this recessed part 15b, and a light receiving part 23 provided on the semiconductor substrate 19b at the first surface side so as to correspond to this lens 16b. The light receiving part 23 receives a light from the vertical direction (thickness direction) of the semiconductor substrate 19b.

The laser diode array 17 is formed so that the lens 16a and the beam emitting part 21 of each laser diode LD are mounted on the clad layer 11 of the optical waveguide substrate 30 through a conductive adhesive material (e.g., soldering material) so as to face the mirror part 14a provided at one end of each optical waveguide 13.

The photo diode array 18 is also formed so that the lens 16b and the light receiving part 23 of each photo diode PD are mounted on the clad layer 11 of the optical waveguide substrate 30 through a conductive adhesive material (e.g., soldering material) so as to face the mirror part 14b provided at the other end of each optical waveguide 13.

In the optical interconnection assembled circuit in this first embodiment, the light signal output from the laser diode array 17 vertically to the substrate is condensed by each lens 16a formed on the semiconductor substrate 19a and the light path is changed by the mirror 14a of each optical waveguide 13 (13a, 13b) so that the light signal goes horizontally to the substrate, then transmitted in the optical waveguide 13. After this, the light path is changed again by each mirror part 14b so that the light signal goes vertically to the substrate, is output from the optical waveguide 13, and condensed by the lens 16b formed on the semiconductor substrate 19b. Then, the light signal is subjected to a photoelectric conversion process in the photo diode array 18 and output as an electric signal.

Consequently, low loss and high density optical connection is realized between each of the plural laser diodes LD of the laser diode array 17 and each of the plural optical waveguides 13 of the optical waveguide array through each lens 16a formed on the semiconductor substrate 19a and the mirror part 14a provided at one end of each optical waveguide 13, as well as between each of the plural photo diodes PD of the photo diode array 18 and each of the optical waveguides 13 through each lens 16b formed on the semiconductor substrate 19b and the mirror part 14b provided at the other end of each optical waveguide 13. Furthermore, the lenses 16a and 16b are formed unitarily on each of the semiconductor substrates 19 (19a and 19b) of the laser diode array 17 and the photo diode array 18 while the mirror parts (14a and 14b) are formed unitarily at both ends of each of the optical waveguides 13 (13a and 13b). Thus no optical parts are required between each of the optical waveguides 13 and each of the optical elements (light emitting and photo diodes), so that the optical interconnection assembled circuit can be configured with less parts and in less manufacturing processes.

The laser diode array 17 and the photo diode array 18 should preferably be surface light emitting or surface light receiving diodes capable of two-dimensional array disposition and preferred to the surface mounting with use of a flip-chip respectively.

Next, there will be described briefly how to manufacture each the major components of the optical interconnection assembled circuit in this first embodiment of the present invention.

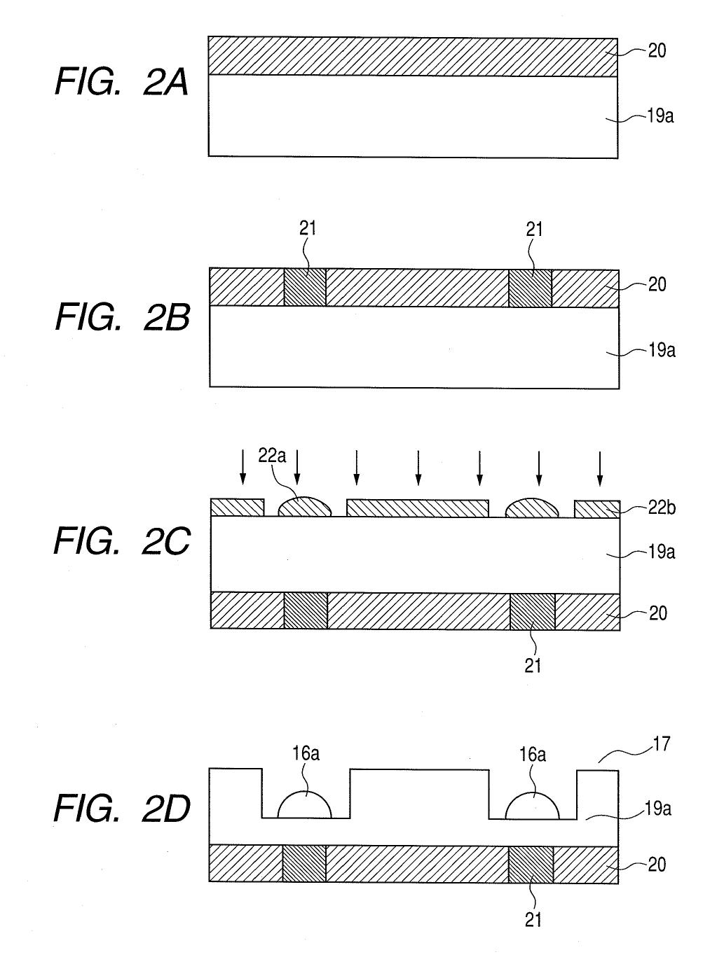

FIGS. 2A through 2D are cross sectional views of a light emitting array to be built in the optical interconnection assembled circuit in this first embodiment of the present invention with respect to its manufacturing processes (as an example of how to form the laser diode array 17).

FIG. 2A is a drawing that shows how an epitaxial layer 20 is formed on the semiconductor substrate 19a. The material of the semiconductor substrate 19a may be GaAs (gallium arsenide), InP (indium phosphide), or the like used generally for optical elements of composite semiconductors. As described above, however, the material should preferably be transparent to the emitted light wavelength so as to prevent an increase of the light propagation loss that might otherwise occur when the light passes through the semiconductor substrate 19a.

Next, the beam emitting part 21 is formed as shown in FIG. 2B in a process such as photolithography, etching, or the like carried out for the epitaxial layer 20. The details of the manufacturing method will not be described here, but a mirror structure is required in or around the beam emitting part 21 so that the light from the beam emitting part 21 can be emitted toward the semiconductor substrate 19a.

After this, passivations 22a and 22b are patterned in a lithographic process carried out for the surface of the semiconductor substrate 19a, which is at the opposite side of the epitaxial layer 20. Here, a photosensitive resist film or a silicon oxide film may be used as the material of the passivations 22a and 22b if the film is resistant enough to the semiconductor etching process carried out to form the lenses to be described later. The passivation 22a should be formed to have a curbed surface, for example, with interferential lithography so as to effectively form the lenses during semiconductor etching.

After this, the lens 16a is formed as shown in FIG. 2D on the semiconductor substrate 19a in the semiconductor etching process, thereby completing forming of the laser diode array 17. Although the semiconductor etching method is not described especially here, it may be any of dry-etching that uses a plasma gas, wet etching that uses a chemical agent, and a combination of those. While there has been described only one example of how to manufacture the laser diode array 17, the same procedures may also be applied to manufacture the photo diode array 18, which is another major component of the optical interconnection assembled circuit of the present invention.

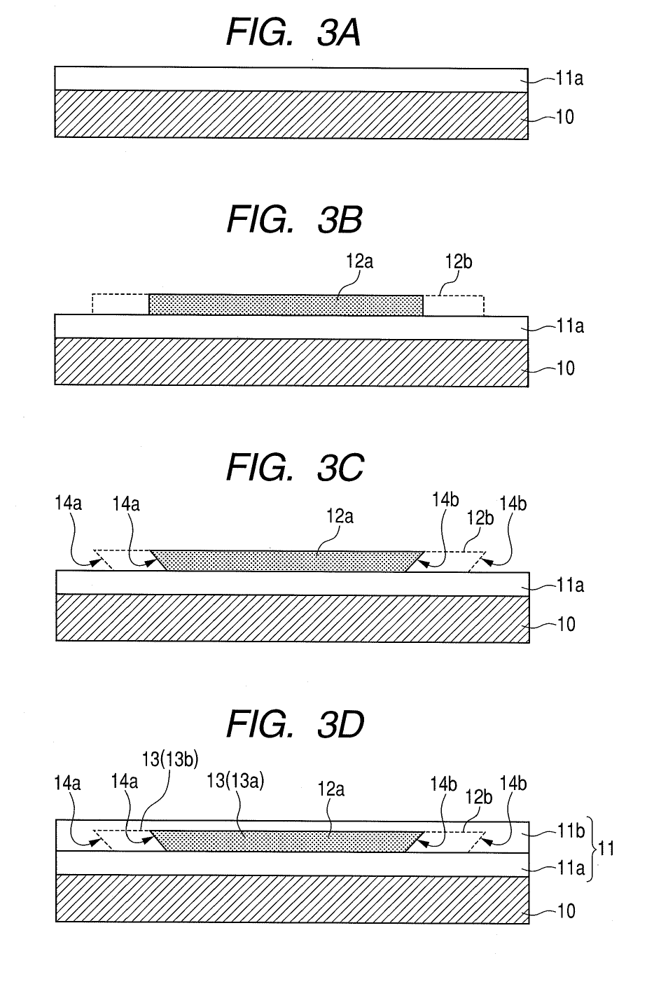

FIGS. 3A through 3D are cross sectional views of an optical waveguide substrate to be built in the optical interconnection assembled circuit in the first embodiment of the present invention with respect to the manufacturing processes (as an example of how to manufacture the optical waveguide substrate).

FIG. 3A is a drawing for showing how to form the clad layer 11a on the substrate 10 by a method of coating or sticking. The material of the substrate 10 is glass epoxy or the like to be used generally for printed boards. The material of the clad layer 11a should preferably be a photosensitive polymer material that is excellent in affinity with the printed board process more than quartz materials and to be easily formed with lithography.

After this, as shown in FIG. 3B, core cubic patterns 12a and 12b are formed on the top surface of the clad layer 11a in a lithography process. The material of the core patterns 12a and 12b should preferably be photosensitive polymer just like the clad layer 11a.

Next, as shown in FIG. 3C, tapered mirror parts 14a and 14b are formed at both ends of the core patterns 12a and 12b respectively. Dicing, a physical process that uses a laser beam, or such a method as inclining lithography can be used to form the mirror parts 14a and 14b. Furthermore, the surfaces of the mirror parts 14a and 14b are provided with air walls respectively so as to realize full reflection by making good use of the difference of the refractive index between the air and the core or be covered with a metal such as Au or the like by making good use of evaporation, plating, etc. to reflect the light more efficiently.

Next, as shown in FIG. 3D, the core patterns 12a and 12b are covered and enclosed by the clad layer 11b respectively, thereby the optical waveguide substrate 30 is completed. As described above, the optical waveguide substrate 30 includes an optical waveguide array that includes plural optical waveguides 13 (13a and 13b) having the cores 12 (core patterns 12a and 12b) respectively made of a material having a refractive index higher than that of the clad layer 11. Although the optical waveguide substrate 30 described in the above example includes a single layer optical waveguide array, the procedures described in FIGS. 3A through 3D can also apply repetitively to form a multilayer optical waveguide array.

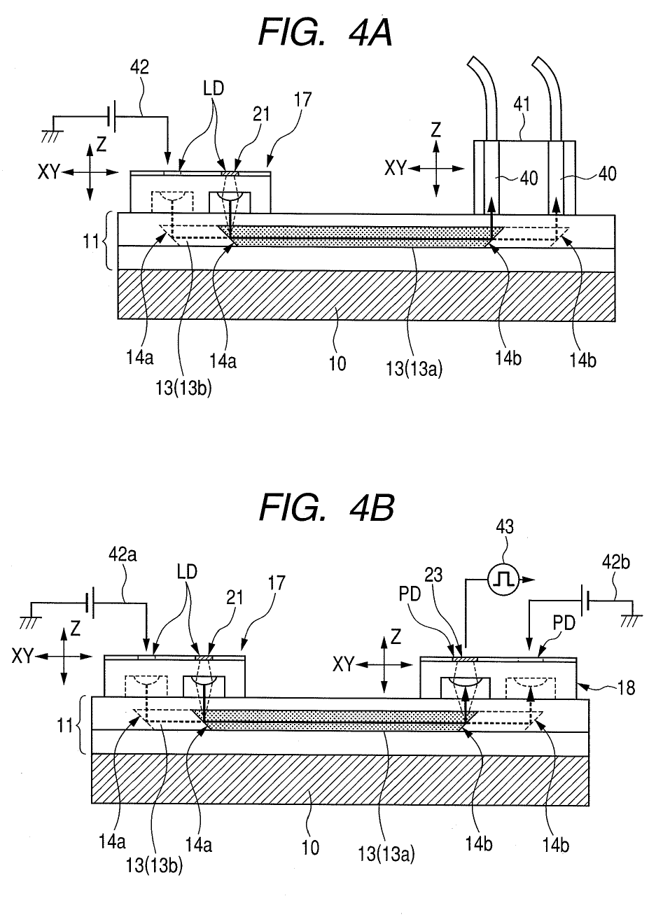

FIGS. 4A and 4B are cross sectional views of the optical interconnection assembled circuit in this first embodiment of the present invention with respect to the manufacturing processes (as an example).

FIG. 4A illustrates how to mount the laser diode array 17 on the optical waveguide substrate 30. FIG. 4B illustrates how to mount the photo diode array 18 on the optical waveguide substrate 30.

As shown in FIG. 4A, the laser diode array 17 is applied a bias 42 so as to be positioned and to emit a light. The light is then moved horizontally (XY direction) and vertically (Z direction) with respect to the substrate and entered to the mirror part 14a of each of the optical waveguides 13 (13a and 13b). At this time, the light emitted from the other end of the mirror part of each optical waveguide 13 is monitored through the fiber 40 having a connector 41 to detect the position of the maximum light intensity, then the laser diode array 17 is fastened on the optical waveguide substrate 30 there.

After this, as shown in FIG. 4B, the photo diode array 18 is moved closer to the top surface of the mirror part 14b of each of the optical waveguides 13 (13a and 13b) while the laser diode array is applied a bias 42a to emit a light. Then, as described above, while the photo diode array 18 is applied a bias 42b, the electric signal 43, after the photoelectric conversion by each optical element, is monitored to detect the position of the maximum signal intensity. Then, the photo diode array 18 is fastened on the optical waveguide substrate 30 there.

This completes the description to how to manufacture the optical interconnection assembled circuit shown in FIG. 1.

As described above, according to this first embodiment, the optical connection loss to be caused by spreading of the beam output from the laser diode LD or the optical waveguide 13 can be suppressed without using any optical parts between each optical waveguide 13 and each photonic device (consisting of a light emitting LD and a photo diode PD), since light signals are exchanged between the laser diode LD of the laser diode array 17 and the optical waveguide 13 (core 12) of the optical waveguide array 13 through the lens 16a provided on the semiconductor substrate 19a of each laser diode LD and the mirror part 14a of each optical waveguide 13 while light signals are exchanged between each photo diode PD of the photo diode array 18 and each optical waveguide 13 (core 12) of the optical waveguide array through the lens 16b provided on the semiconductor substrate 19b of the photo diode PD and the mirror part 14b of the optical waveguide 13. As described above, the laser diode array 17 that includes the lens 16a on, the same semiconductor substrate 19a is mounted on one mirror part 14a of the optical waveguide array and the photo diode array 18 that includes the lens 16b on the same semiconductor substrate 19b is mounted on the other mirror part 14b of the optical waveguide array.

Furthermore, because the optical element arrays (the laser diode array 17 and the photo diode array 18) and the lenses (16a and 16b) can be formed together on the same semiconductor substrates 19 (19a and 19b) respectively, the number of parts and manufacturing processes can be suppressed from increasing and the manufacturing yield can be prevented from getting worse that has been a conventional problem.

Furthermore, because the mirror parts 14a provided at one ends of the plural optical waveguides 13 (each of 13a and 13b) of the optical waveguide array and the plural laser diodes LD of the laser diode array 17 can be disposed in a zigzag pattern in the direction (e.g., Y direction) of the disposed plural optical waveguides 13 and the mirror parts 14b provided at the other ends of the plural optical waveguides 13 of the optical waveguide array and the plural photo diodes PD of the photo diode array 18 can be disposed in a zigzag pattern in the direction (e.g., Y direction) of the disposed plural optical waveguide 13s, the channel pitch can be narrowed more and the signal wirings can be laid more densely than the case in which those items are disposed linearly.

This is why this first embodiment can provide an optical interconnection assembled circuit having an optical element structure and an optical connection part capable of reducing the number of parts and components, as well as the number of manufacturing processes respectively to realize lower manufacturing costs, and realize high disposition of those parts and components most efficiently.

Here, in order to narrow the space between adjacent laser diodes LD, it is required to suppress spreading of the light emitted from each beam emitting part 21 and suppress the light interference. In this first embodiment, the light spreading and the light interference can be prevented by the lens 16a included in each of the laser diodes LD. This is why the space between adjacent laser diodes LD can be narrowed, thereby the laser diodes LD can be disposed very closely in a zigzag pattern.

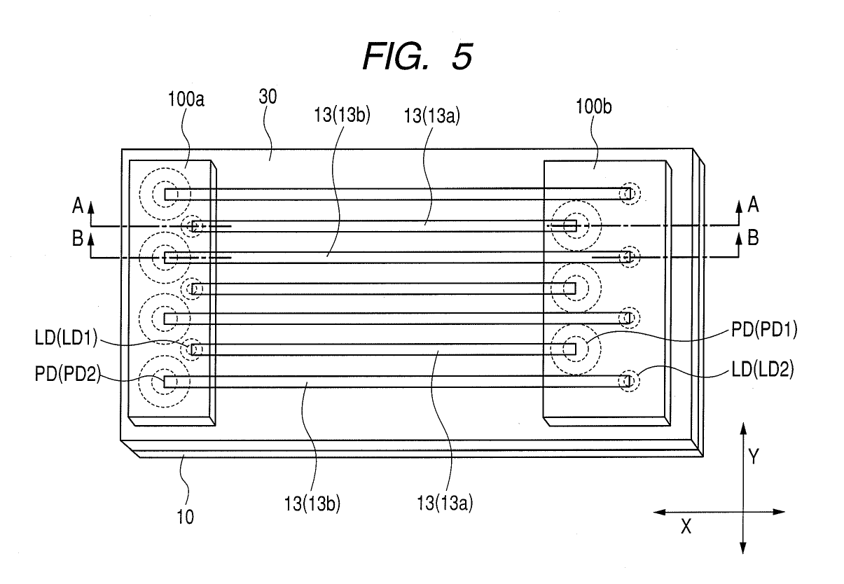

FIG. 5 is a top view of an optical interconnection assembled circuit with respect to its schematic configuration in a variation of the first embodiment of the present invention.

The optical interconnection assembled circuit in this variation is basically the same in configuration as that of the first embodiment except for the following points.

In the first embodiment, the laser diode array 17 in which the laser diodes LD are disposed in the first and second rows is connected optically to the photo diode array 18 in which the photo diodes PD are disposed in the first and second rows on the optical waveguide substrate 30 respectively.

In this variation, however, the laser diodes LD are disposed in the first row and the photo diodes PD are disposed in the second row. In other words, an optical element array 100a in which the laser diodes LD and the photo diodes PD are disposed alternately in the direction of the disposed optical waveguides 13 of the optical waveguide array is connected optically to an optical element array 100b in which, for example, the photo diodes PD are disposed in the first row and the laser diodes LD are disposed in the second row, that is, the photo diodes PD and the laser diodes LD are disposed alternately in a zigzag pattern in the direction of the disposed optical waveguides 13 of the optical waveguide array on the optical waveguide substrate 30. Needless to say, each laser diode LD of the optical element array 100a is paired with a photo diode PD of the optical element array 100b and each laser diode LD of the optical element array 100b is paired with a photo diode PD of the optical element array 100a.

Even in this variation, just like in the first embodiment described above, it is possible to provide an optical interconnection assembled circuit that includes an optical element structure and an optical connection part capable of reducing the number of parts and components, as well as the number of manufacturing processes so as to realize high dense disposition of those parts and components most efficiently.

### Second Embodiment

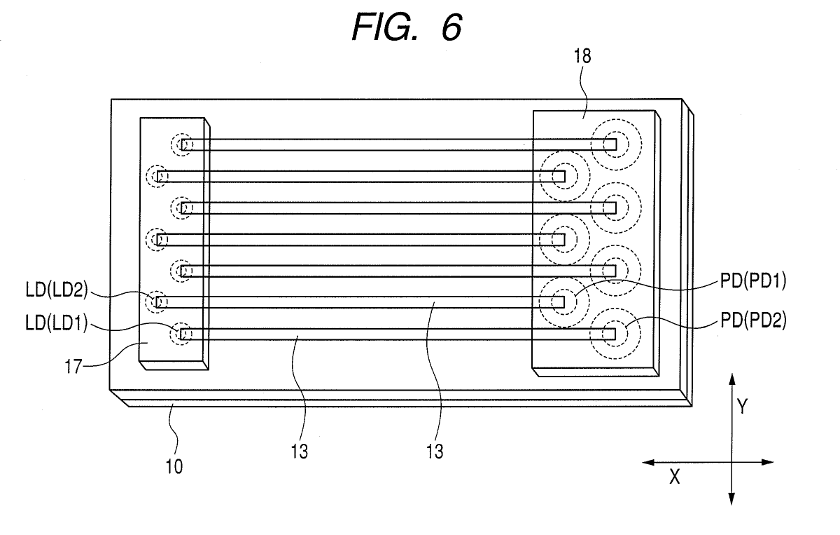

FIG. 6 is a flat (top) view of an optical interconnection assembled circuit in this second embodiment of the present invention.

The optical interconnection assembled circuit in this second embodiment is basically the same in configuration with that in the first embodiment except for the following points.

In the first embodiment described above, as shown in FIGS. 1B through 1D, the optical waveguides 13a, as well as the optical waveguides 13b having a longer light path than that of the optical waveguides 13a respectively are disposed alternately and repetitively in the second direction (e.g., Y direction) and the laser diode LD1 in the first row (inside that in the second row) of the laser diode array 17 is connected optically to the photo diode PD1 in the first row (inside that in the second row) of the photo diode array 18 in the optical waveguide 13a of which light path is shorter than that of the optical waveguide 13b (inside—inside optical connection) while the laser diode LD2 in the second row (outside that in the first row) of the laser diode array 17 is connected optically to the photo diode PD2 in the second row (outside that in the first row) of the photo diode array 18 in the optical waveguide 13b of which light path is longer than that of the optical waveguide 13a (outside—outside optical connection), thereby the mirror parts (14a and 14b provided at both ends of each of the optical waveguides 13 (13a and 13b), as well as the laser diodes LD of the laser diode array 17 and the photo diodes PD of the photo diode array 18 are disposed in a zigzag pattern in the second direction.

On the other hand, in this second embodiment, as shown in FIG. 6, plural optical waveguides 13 having the same length are disposed so as to be shifted in position alternately and the laser diode LD1 in the first row (inside that in the second row) of the laser diode array 17 is connected optically to the photo diode PD2 in the second row (outside that in the first row) of the photo diode array 18 in the optical waveguide 13 (inside-outside optical connection) while the laser diode LD2 in the second row (outside that in the first row) of the laser diode array 17 is connected optically to the photo diode PD1 in the first row of the photo diode array 18 in the optical waveguide 13 (outside-inside optical connection), thereby the mirror parts (14a and 14b) at both ends of each of the optical waveguides 13, as well as the laser diodes LD of the laser diode array 17 and the photo diodes PD of the photo diode array 18 are disposed in a zigzag pattern respectively in the second direction.

In the optical interconnection assembled circuit in this second embodiment, just like in the first embodiment, the light signal output from the laser diode array 17 vertically with respect to the substrate is condensed by the lens 16a formed on the semiconductor substrate 15a and its path is changed by the mirror part 14a provided at one end of each optical waveguide 13 so that the light signal goes horizontally with respect to the substrate, then transmitted in the optical waveguides 13. After this, the light path is converted again by the mirror part 14b provided at the other end of each optical waveguide 13 so that the light signal goes vertically with respect to the substrate, then the light signal is output from the optical waveguide 13 and condensed by the lens 16b formed on the semiconductor substrate 15b, then subjected to photoelectric conversion in the photo diode array 18 so as to be taken out as an electric signal.

Because of the zigzag disposition of optical element arrays and the optical waveguide arrays, optical elements and optical waveguides can be disposed at narrower and higher dense pitches just like in this second embodiment than the linear disposition of those elements.

Furthermore, in this second embodiment, plural optical waveguides 13 having the same length are shifted alternately in disposition, so that those optical guides can be set equally in length more than in the first embodiment described above. As a result, the optical signal transmission time between the laser diode LD and the photo diode PD can be suppressed more from varying.

This second embodiment can also be combined with the variation of the first embodiment.

### Third Embodiment

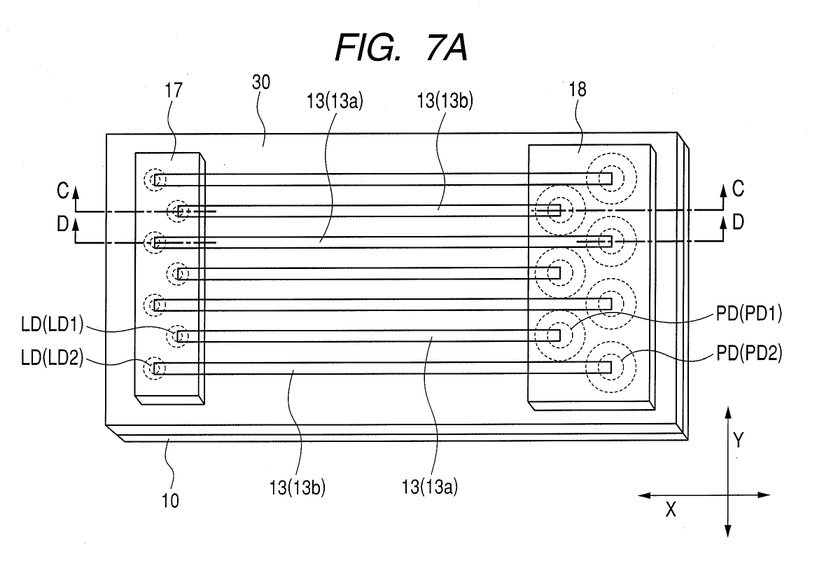

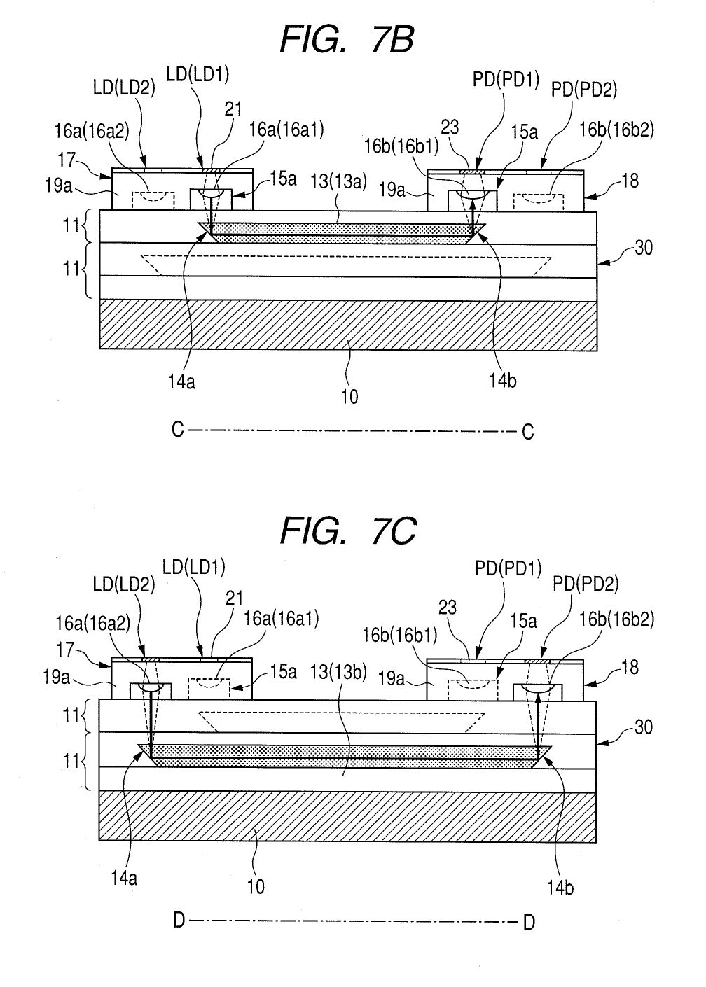

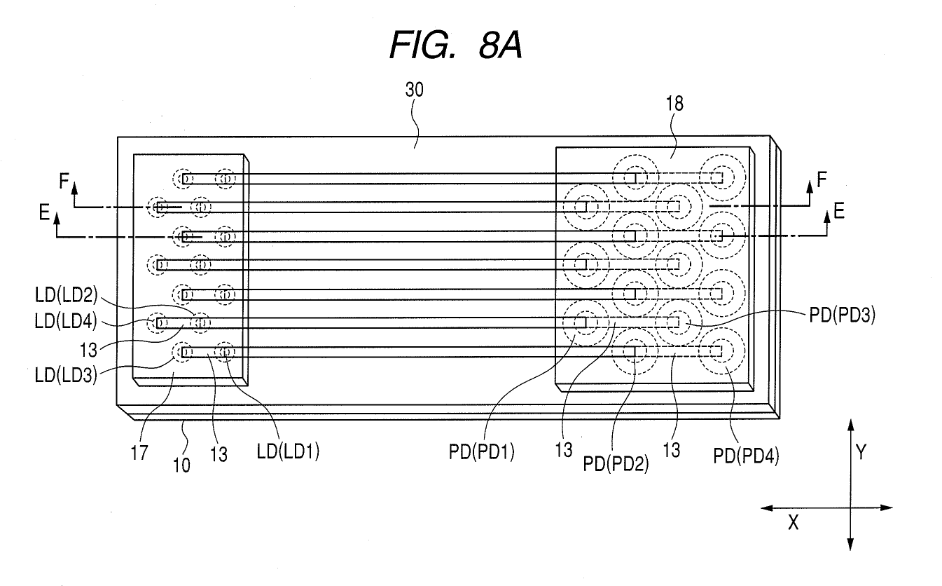

FIGS. 7A through 7C are drawings related to an optical interconnection assembled circuit in this third embodiment of the present invention.

FIG. 7A is a flat (top) view of the optical interconnection assembled circuit with respect to its schematic configuration.

FIG. 7B is a cross sectional view taken on line C-C of FIG. 7A.

FIG. 7C is a cross sectional view taken on line D-D of FIG. 7A.

The configuration of the optical interconnection assembled circuit in this third embodiment is basically the same as that in the first embodiment except for the following points.

In the first embodiment, the optical waveguide substrate 30 has a single layer optical waveguide array.

In this third embodiment, however, the optical waveguide substrate 30, as shown in FIGS. 7A through 7C, has a multilayer structure in which the optical waveguides 13a, as well as 13b that is longer than the optical waveguide 13a are formed in different layers. In this third embodiment, the optical waveguide 13b is formed in the first layer and the optical waveguide 13a is formed in the second layer provided above the first layer. In the flat view, the optical waveguides 13a and 13b are disposed just like in the first embodiment (FIG. 1B) as shown in FIG. 7A.

In the optical interconnection assembled circuit in this third embodiment, as shown in FIG. 7B, the light signal output from the laser diode LD1 of the laser diode array 17 vertically with respect to the substrate is condensed by the lens 16a (16a1) formed on the semiconductor substrate 19a, then the light path is changed by the mirror part 14a provided at one end of each optical waveguide 13a in the upper layer so that the light signal goes horizontally with respect to the substrate, thereby the light signal is transmitted in the optical waveguide 13a. After this, the light path is changed again by the mirror part 14b provided at the other end of each optical waveguide 13a so that the light signal goes vertically with respect to the substrate, thereby the light signal goes out from the optical waveguide 13a and it is condensed by the lens 16b (16b1) formed on the semiconductor substrate 19b, then subjected to photoelectric conversion by the photo diode PD1 of the photo diode array 18 so as to be taken out as an electric signal.

Furthermore, as shown in FIG. 7C, as described above, the light signal output from the laser diode LD2 of the laser diode array 17 vertically with respect to the substrate is condensed by the lens 16a (16a2) formed on the semiconductor substrate 19a, then the light path is changed by the mirror part 14a provided at one end of each optical waveguide 13b in the lower layer so that the light signal goes horizontally with respect to the substrate, thereby the light signal is transmitted in the optical waveguide 13a. After this, the light path is changed again by the mirror part 14b provided at the other end of each optical waveguide 13b so that the light signal goes vertically with respect to the substrate, thereby the light signal goes out from the optical waveguide 13b and it is condensed by the lens 16b (16b2) formed on the semiconductor substrate 19b, then subjected to photoelectric conversion by the photo diode PD2 of the photo diode array 18 so as to be taken out as an electric signal.

Because of this structure, as shown in FIGS. 7B and 7C, the lens 16a1 of the laser diode LD1 of the laser diode array 17 and the lens 16a2 of the laser diode LD2 of the laser diode array 17 come to be different in the distance to the mirror part 14a of the subject optical waveguide 13 (13a, 13b) to which they are connected optically. This is why when the curvature and curvature radius of each of the lenses 16a1 and 16a2 can be changed to optimize the focal point in accordance with the distance to the subject optical waveguide 13 (13a, 13b). Concretely, the recessed part 15a formed around each of the lenses 16a1 and 16a2 can be deepened to decrease the curvature and increase the groove diameter so as to increase the curvature diameter. Therefore, the lens 16a1 corresponding to the laser diode LD1 in the first row of the laser diode array 17 becomes shorter in the distance to the mirror part 14a of the subject optical waveguide 13 (13a, 13b) than the lens 16a2 corresponding to the laser diode LD2 in the second row. Thus the curvature and curvature radius of the lens 16a1 can be set smaller than those of the lens 16a2 by forming the recessed part 15a corresponding to the laser diode LD1 deeper than the recessed part 15a corresponding to the laser diode LD2 and by setting the diameter of the former smaller than that of the latter.

Furthermore, as described above and as shown in FIGS. 7B and 7C, the lens 16b1 of the photo diode PD1 in the first row of the photo diode array 18 and the lens 16b2 of the photo diode PD2 in the second row of the photo diode array 18 come to be different in the distance to the mirror part 14b of each of the optical waveguides 13 (13a and 13b) to which they are connected optically. This is why the curvature and curvature radius of each of the lenses 16b1 and 16b2 can be changed to optimize the focal point in accordance with the distance to each of the optical waveguides 13 (13a and 13b). Concretely, the recessed part 15b formed around each of the lenses 16b1 and 16b2 is deepened more to decrease the curvature and increase the groove diameter, thereby increasing the curvature radius. Therefore, the lens 16b1 corresponding to the photo diode PD1 in the first row of the photo diode array 18 becomes shorter than the lens 16b2 corresponding to the photo diode PD2 in the second row with respect to the distance to the mirror part 14b of each of the optical waveguides 13 (13a and 13b). Thus the curvature and curvature radius of the lens 16b1 can be set smaller than those of the lens 16b2 by forming the recessed part 15a corresponding to the photo diode PD1 in the first row deeper than the recessed part 15a corresponding to the photo diode PD2 in the second row and by setting the diameter of the former smaller than that of the latter.

The lenses 16b1 and 16b2 can be changed in curvature and in curvature radius simultaneously and more easily by changing the pattern of the semiconductor etching protection film on the same semiconductor substrate.

Because the optical waveguide arrays are formed in multiple layers that are laminated into one and connected optically to the optical element arrays as described above, the optical elements and the optical waveguides can be integrated closely in a smatter area.

While the optical waveguide 13b is formed in the first (lower) layer and the optical waveguide 13a is formed in the second (upper) layer in the optical waveguide substrate 30 in this third embodiment, the optical waveguide substrate 30 may also be configured so that the optical waveguide 13a is formed in the first (lower) layer and the optical waveguide 13b is formed in the second (upper) layer.

Furthermore, while the optical waveguide substrate 30 has a multilayer structure in which the optical waveguides 13a, as well as the optical waveguides 13b that are longer than the optical waveguides 13a are formed in different layers, the optical waveguide substrate 30 can also be configured by combining this third embodiment with each of the variation of the first embodiment and the second embodiment.

### Fourth Embodiment

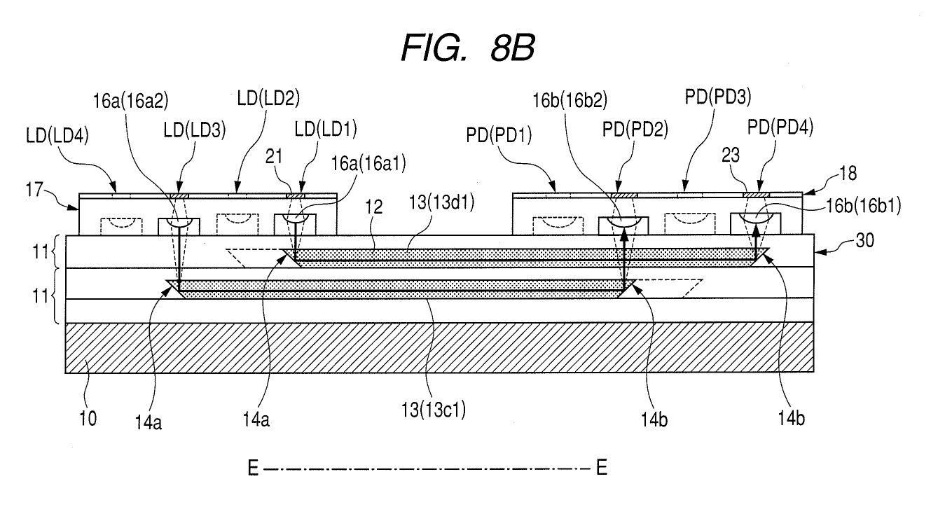

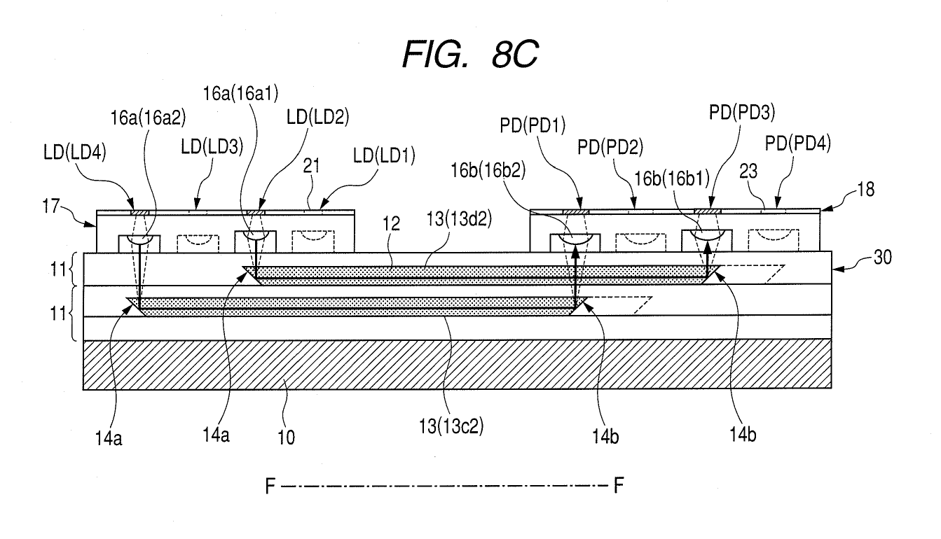

FIGS. 8A through 8C are drawings related to an optical interconnection assembled circuit in this fourth embodiment.

FIG. 8A is a flat (top) view of the optical interconnection assembled circuit.

FIG. 8B is a cross sectional view taken on line E-E of FIG. 8A.

FIG. 8C is a cross sectional view taken on line F-F of FIG. 8A.

The configuration of the optical interconnection assembled circuit in this fourth embodiment is basically the same as that in the second embodiment except for the following points.

In the second embodiment, the optical waveguide array of the optical waveguide substrate 30 consists of a single layer.

On the other hand, in this fourth embodiment, the optical waveguide substrate 30 has two optical waveguide arrays employed in the second embodiment. Those two layers are stacked in the thick direction of the substrate 10. In this fourth embodiment, the optical waveguide 13 in the first (lower) layer and the optical waveguide 13 in the second (upper) layer are disposed so that they are overlapped in the flat view and the mirror parts (14a and 14b) are disposed so as to be shifted from each other in the first direction.

In this fourth embodiment, the laser diodes LD are disposed in four rows in the laser diode array 17 and the photo diodes PD are disposed in four rows in the photo diode array 18.

In this fourth embodiment, as shown in FIG. 8, the laser diode LD1 in the first row of the laser diode array 17 (the first row closest to the photo diode array 18) is connected optically to the photo diode PD4 in the fourth row of the photo diode array 18 (the fourth row closest to the laser diode array 17) in the optical waveguide 13 (13d1) in the second layer (optical connection between the first and fourth rows). And as shown in FIG. 8C, the laser diode LD2 in the second row of the laser diode array 17 (the second row closest to the photo diode array 18) is connected optically to the photo diode PD3 in the third row of the photo diode array 18 (the third row closest to the laser diode array 17) in the optical waveguide 13 (13d2) in the second layer (optical connection between the second and third rows). And as shown in FIG. 8B, the laser diode LD3 in the third row of the laser diode array 17 (the third row closest to the photo diode array 18) are connected optically to the photo diode PD2 in the second row of the photo diode array 18 (the second row closest to the laser diode array 17) in the optical waveguide 13 (13c1) in the second layer (optical connection between the third and second rows).

And furthermore, as shown in FIG. 8C, the laser diode LD4 in the fourth row of the laser diode array 17 (the fourth row closest to the photo diode array 18) is connected optically to the photo diode PD1 in the first row of the photo diode array 18 (the first row closest to the laser diode array 17) in the optical waveguide 13 (13c2) in the first layer (optical connection between the fourth and first rows).

In the optical waveguide 13d1 (FIG. 8B), the mirror parts 14a provided at one end is disposed to face the lens 16a1 of the laser diode LD1 in the first row while the mirror part 14b provided at the other end is disposed to face the lens 16b1 of the laser diode LD4 in the fourth row.

In the optical waveguide 13c1 (FIG. 8B), the mirror part 14a provided at one end is disposed to face the lens 16a2 of the laser diode LD3 in the third row while the mirror part 14b provided at the other end is disposed to face the lens 16b2 of the laser diode LD2 in the second row.

The optical waveguides 13c1 and 13d1 are configured so that the mirror part 14a provided at one end of the optical waveguide 13c1 is positioned outside the mirror part 14a provided at one end of the optical waveguide 13d1 and the mirror part 14b provided at the other end of the optical waveguide 13d1 is positioned outside the mirror part 14b provided at the other end of the optical waveguide 13c1 and those mirror parts 14a and 14b come to lie one upon another at a top view.

In the optical waveguide 13d2 (FIG. 8C), the mirror part 14a provided at one end is disposed to face the lens 16a1 of the laser diode LD2 in the second row while the mirror part 14b provided at the other end is disposed to face the lens 16b1 of the photo diode PD3 in the third row.

In the optical waveguide 13c2 (FIG. 8C), the mirror part 14a provided at one end is disposed to face the lens 16a2 of the laser diode LD4 in the fourth row while the mirror part 14b provided at the other end is disposed to face the lens 16b2 of the photo diode PD1 in the first row.

The optical waveguides 13c2 and 13d2 are configured so that the mirror part 14a provided at one end of the optical waveguide 13c2 is positioned outside the mirror part 14a provided at one end of the optical waveguide 13d2 and the mirror part 14b provided at the other end of the optical waveguide 13d2 is positioned outside the mirror part 14b provided at the other end of the optical waveguide 13c2 and those mirror parts 14a and 14b come to lie one upon another at a top view.

As described above for the structure of the optical interconnection assembled circuit, because the optical waveguide array consisting of plural optical waveguides 13 that are shifted alternately so as to be staggered in disposition on the same plane is formed in multiple layers, the wirings can be disposed at narrower pitches most efficiently in a smaller area.

The optical waveguide substrate 30 formed here by laminating two optical waveguide arrays employed in the second embodiment can also be formed by laminating the optical waveguide arrays in each of the first embodiment and in the variation of the first embodiment in two layers.

If the optical waveguides 13 in the lower and upper layers are laid one upon another just like in this fourth embodiment, as shown in FIG. 8C (top view), the light signals of which path is changed by the mirror part 14b provided at the other end of the optical waveguide 13 in the lower layer are passed through the optical waveguide 13 in the upper layer and received by the corresponding photo diode PD1. In this case, the light signals of which vectors are different by 90 degrees from each other do not interfere with each other. This is why the optical waveguides can be disposed one upon another flatly so as to realize high-dense disposition of optical waveguides (to provide multiple channels) just like in this fourth embodiment.

### Fifth Embodiment

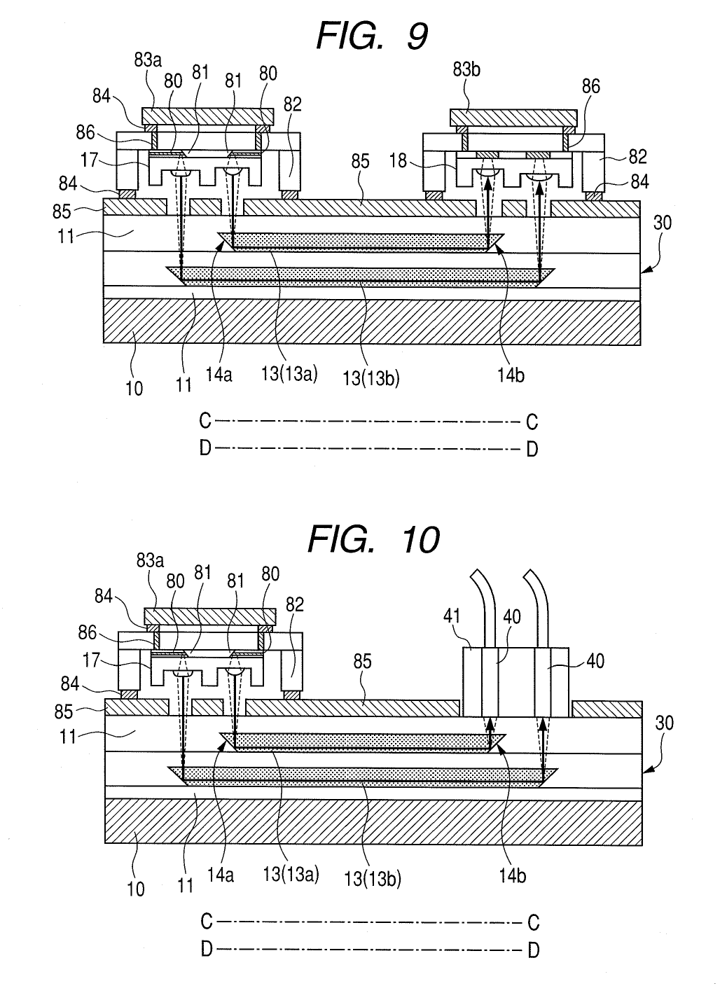

FIG. 9 is a cross sectional view of an optical interconnection assembled circuit in this fifth embodiment. Here, as an example, the optical element array (the laser diode array 17 or the photo diode array 18) employed in the optical interconnection assembled circuit in the third embodiment is packaged and mounted on an optical waveguide substrate.

The cross sectional view shown in FIG. 9 is taken on two lines C-C and D-D of FIG. 7A in the third embodiment. Those two lines C-C and D-D are laid one upon another here.

As shown in FIG. 9, the laser diode array 17 or the photo diode array 18 is put in a package 82, in which integrated circuits 83a and 83b are mounted. Each of those integrated circuits 83a and 83b includes a circuit that drives each optical element array, a cross-over switch, logic circuits, etc. The laser diode array 17 or the photo diode array 18 is connected to the integrated circuits 83a and 83b through high frequency electric wirings provided in the package 82 respectively. The package 82 is mounted on an electrical wiring layer 85 formed on the top surface of the optical waveguide substrate 30 with soldering bumps 84 or the like, so that the package 82 comes to be connected optically to the optical waveguides 13 (13a and 13b), as well as electrically to the power supply, the ground, etc. at the same time.

Because of the configuration of the optical interconnection assembled circuit as described above, the light signals exchanged between the laser diode array 17 or the photo diode array 18 and each of the optical waveguides 13 (13a and 13b) can be processed in the integrated circuits 83a and 83b after the photoelectric conversion carried out in the package 82 mounted on the substrate 10.

The laser diode array 17 shown in FIG. 9 includes a laser resonator 80 disposed horizontally with respect to the semiconductor substrate and emits a light vertically due to a mirror 81 (diode structure). The laser diode array 17 structured in such a way can also be used to configure the optical interconnection assembled circuit of the present invention.

As described above, in this fifth embodiment, the subject optical element array (the laser diode array 17 or the photo diode array 18) employed for the optical interconnection assembled circuit in the third embodiment is packaged and mounted on the optical waveguide substrate. In this fifth embodiment, however, any of the optical element arrays (the laser diode array 17 and the photo diode array 18) employed for the optical interconnection assembled circuit in any of the first embodiment, the variation of the first embodiment, the second embodiment, and the fourth embodiment can also be packaged and mounted on the optical waveguide substrate 30.

### Sixth Embodiment

FIG. 10 is a cross sectional view of an interconnection circuit in this sixth embodiment. Here, there will be described a configuration example in which an optical fiber having a connector is used to configure a photo diode array employed for the optical interconnection assembled circuit in the fifth embodiment and mount the photo diode array on the optical waveguide substrate 30.

In FIG. 10, two cross sectional views taken on lines C-C and D-D of FIG. 7A in the third embodiment are laid one upon another.

As shown in FIG. 10, the light signal output from the laser diode array 17 is transmitted in the optical waveguides 13 (13a and 13b), then the light signal path is changed by the mirror part 14b so that the signal goes vertically with respect to the substrate 10 and is output therefrom and connected optically to the optical fiber 40 having the optical connector 41 mounted on the mirror part 14b.

Because of the structure as described above, the optical interconnection assembled circuit can be configured between boards so as to realize high-dense optical connection, for example, between each daughter board and a backplane in a transmission apparatus.

As described above, in the fifth embodiment, each photo diode array employed in the optical interconnection assembled circuit is configured with an optical fiber having a connector. However, this sixth embodiment can be combined with any of the first embodiment, the variation of the first embodiment, the second embodiment, and the fourth embodiment to package any of the optical element arrays (the laser diode array 17 and the photo diode array 18) therein and mount it on the optical waveguide substrate 30 so as to be employed in the optical interconnection assembled circuit.

### Seventh Embodiment

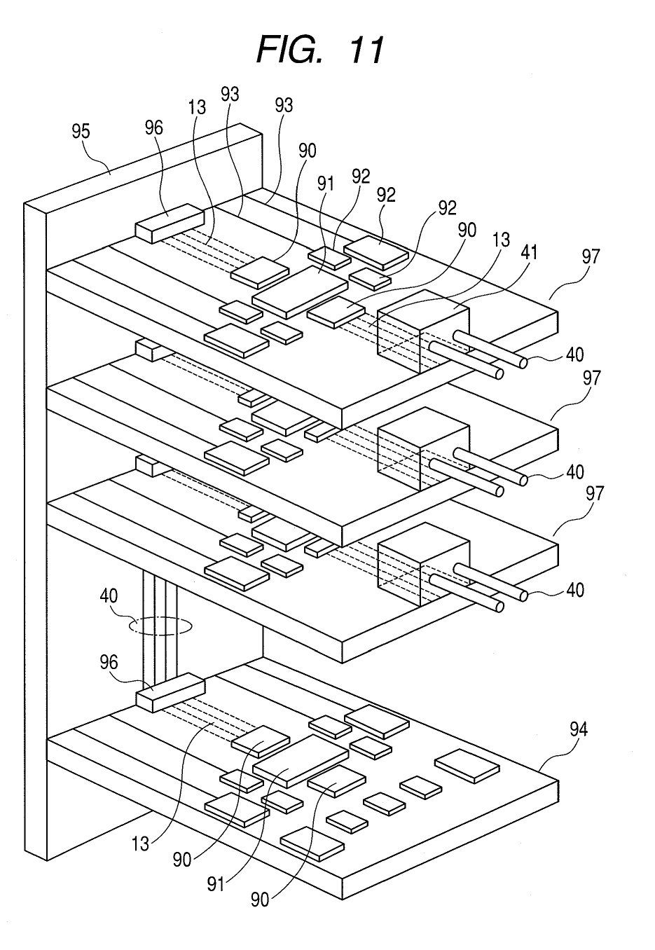

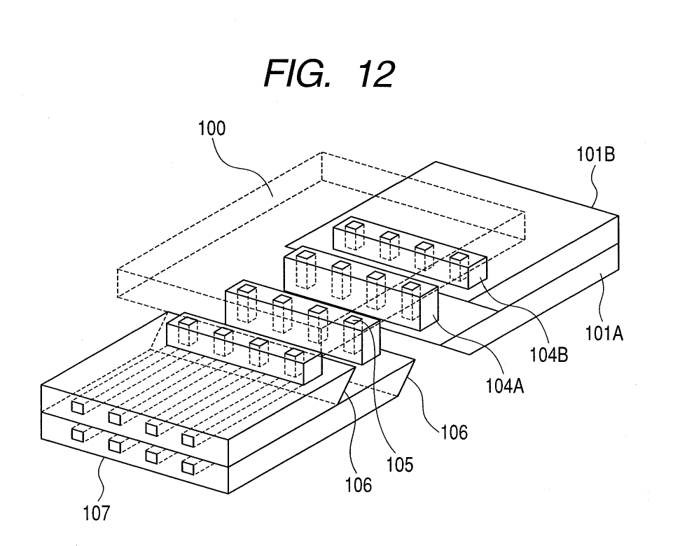

FIG. 11 is a schematic block diagram of an optical interconnection assembled circuit in this seventh embodiment of the present invention. Here, there will be described a configuration example in which the optical interconnection assembled circuit employed in any of the fifth and sixth embodiments is mounted on each daughter board 97 connected to the backplane 95.

As shown in FIG. 11, the light signal to be output to external is inputted to the subject optical waveguide path 13 through an optical fiber 40 from a front part of such a board as an Ethernet one, then converted to an electric signal in the optical element array 90 and processed by an integrated circuit 92. The electric signal is converted again to a light signal by the optical element array 90 and output to an optical connector 96 provided at the backplane side through the optical waveguide 13. Furthermore, the light signals output from each daughter board 97 are collected into a switch card 94 through the optical fiber 40 of the backplane. The signals are then output to the optical element array 90 through the optical waveguide 13 provided on the switch card, then processed in the integrated circuit 91. Those processed signals are input/output to/from each daughter board 97 through the optical element array 90.

While the preferred forms of the present invention have been described, it is to be understood that modifications will be apparent to those skilled in the art without departing from the spirit of the invention.

As described above, therefore, the present invention can provide an optical interconnection assembled circuit having an optical element structure and an optical connection part capable of reducing the number of parts and components, as well as the number of manufacturing processes respectively, thereby realizing a lower price, as well as high-dense disposition of those parts, components, and wirings most efficiently in a transmission apparatus that processes a mass of light signals to be sent/received between boards.

What is claimed is:

1. An optical interconnection assembled circuit comprising:
a substrate that includes plural optical waveguides having partially tapered surfaces respectively; and
an optical element array paired with each of the tapered surfaces,
wherein each of the tapered surfaces and the optical element array are fastened while facing each other, and
wherein a plurality of optical elements of the optical element array are staggered in disposition.

2. The optical interconnection assembled circuit according to claim 1,
wherein the optical element array is configured by a laser diode array, a photo diode array, or a combination of a laser diode row and a photo diode row.

3. The optical interconnection assembled circuit according to claim 1,
wherein the optical waveguide has a first tapered surface and a second tapered surface,
wherein the optical element array facing the first tapered surface is a laser diode array,
wherein the optical element array facing the second tapered surface is a photo diode array, an optical element array composed of a combination of a laser diode sequence and a photo diode sequence, or an optical fiber having a connector.

4. The optical interconnection assembled circuit according to claim 1,
wherein the optical waveguide has a first tapered surface and a second tapered surface,
wherein the optical element array facing the first tapered surface is a photo diode array, and
wherein the optical element array facing the second tapered surface is an optical element array composed of a laser diode row and a photo diode row or an optical fiber having a connector.

5. The optical interconnection assembled circuit according to claim 1,
wherein the optical waveguide includes a first optical waveguide consisting of a first layer and a second optical waveguide laminated at a side of the first optical waveguide, where the optical element array is mounted.

6. The optical interconnection assembled circuit according to claim 5;
wherein the optical element array has lenses on a surface facing the tapered surfaces respectively, and
wherein the curvature differ between the lens facing the first optical waveguide and the lens facing the second optical waveguide.

7. The optical interconnection assembled circuit according to claim 1,
wherein the optical element array has lenses on surfaces facing the tapered surfaces respectively.

8. The optical interconnection assembled circuit according to claim 7,
wherein the optical element array has a photo diode array and a laser diode array, and
wherein the curvature differs between the lens provided for the photo diode array and the lens provided for the laser diode array.

9. The optical interconnection assembled circuit according to claim 7,
wherein each of the lenses is formed in a groove provided on a surface on which the optical element array is mounted with respect to the optical waveguide,
wherein the optical element array has a photo diode array and a laser diode array, and
wherein the depth of the groove is changed between the lens provided for the photo diode array and the lens provided for the laser diode, thereby the optical length up to the optical waveguide is changed.

10. The optical interconnection assembled circuit according to claim 1,
wherein a light sensitive polymer material is used to form each of the core and the clad of the optical waveguide.

11. The optical interconnection assembled circuit according to claim 1,
wherein the optical element array has a first optical element array and a second optical element array connected optically to each other in the optical waveguide,
wherein the first optical array has a first row of optical elements and a second row of optical elements that are disposed in this order sequentially from the side closer to the second optical element array and the first array is shifted by a half pitch from the first row,
wherein the second optical array has a third row of optical elements and a fourth row of optical elements that are disposed in this order sequentially from the side closer to the first optical element array and the second row is shifted by a half pitch from the fourth row,
wherein the third row of optical elements is connected optically to the first row of optical elements, and
wherein the fourth row of optical elements is connected optically to the second row of optical elements.

12. The optical interconnection assembled circuit according to claim 1,
wherein the optical element array has a first optical element array and a second optical element array that are connected optically to each other in the optical waveguide;
wherein the first optical element array has a first row of optical elements and a second row of optical elements that are disposed in this order sequentially from the side closer to the second optical element array and the second row is shifted by a half pitch from the first row,
wherein the second optical element array has a third row of optical elements and a second row of optical elements that are disposed in this order sequentially from the side closer to the first optical element array and the second row is shifted by a half pitch from the fourth row,
wherein the fourth row of optical elements is connected optically to the first row of optical elements, and
wherein the third row of optical elements is connected optically to the second row of optical elements.

13. The optical interconnection assembled circuit according to claim 12,
wherein the optical waveguide has a first optical waveguide consisting of a first layer and a second optical waveguide laminated on the first optical waveguide at a side thereof where the optical element array is mounted,
wherein the first and fourth rows of optical elements are connected optically to each other in the first optical waveguide, and
wherein the second and third rows of optical elements are connected optically to each other in the second optical waveguide.
